(19) United States
(12) Patent Application Publication
(10) Pub. No.: US 2007/0096660 A1
(43) Pub. Date: May 3, 2007

(54) Display device

(76) Inventors: Seung-Hyun Son, Suwon-si (KR); Hyoung-Bin Park, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/592,144

(22) Filed: Nov. 3, 2006

(30) Foreign Application Priority Data
Nov. 3, 2005 (KR) 10-2005-0105058

(51) Int. Cl. G09G 3/10

(52) U.S. Cl. 315/169.3

(57) ABSTRACT

A device including a first substrate and a second substrate facing each other, and including a plurality of cells defined between the first and second substrates, an electron accelerating and emitting unit, disposed between the first and second substrates, for accelerating and emitting electrons, a gas including N₂ within the cell, the gas capable of being excited by the electrons emitted by the electron accelerating and emitting unit to generate ultraviolet light, and a light emitting layer disposed on an outer surface of one of the first and second substrates, the light emitting layer capable of being excited by the ultraviolet light to generate visible light.

### BACKGROUND OF THE INVENTION

1. Field of the Invention

The invention relates to electron emitting devices employable by devices, e.g., display devices and flat lamps, which allow the devices to operate at reduced driving voltages and/or have improved luminous efficiency.

2. Description of the Related Art

Flat panel display devices, e.g., plasma display panels (PDPs), liquid crystal displays (LCDs), are being used in lieu of conventional cathode ray tubes. In PDPs, a discharge gas may be filled between two substrates on which a plurality of electrodes may be formed. When a discharge voltage is applied to the discharge gas to generate ultraviolet (UV) light, which in turn excite phosphor layers formed in a predetermined pattern, thereby emitting visible light and displaying a desired image on the PDP.

PDPs generally include a noble gas, such as Xe, Ne. In conventional PDPs, when a predetermined voltage is applied across electrodes of the PDP, the noble gas may be ionized into a plasma state, i.e., plasma discharge, and UV light may be emitted. The excited Xe gas may be stabilized when releasing photons of light energy, i.e., while generating UV light.

In order to display images in the conventional plasma display panel, a relatively high amount energy is required for ionizing the discharge gas, and thus, a high driving voltage is applied. However, plasma display panels generally have a relatively low luminous efficiency. Similarly, flat panel lamps employing conventional plasma cell structures to emit light also generally require a relatively high driving voltage, and have a relatively low luminous efficiency.

### SUMMARY OF THE INVENTION

The invention is therefore directed to electron emitting devices employable in device, e.g., display devices and flat lamps, which substantially overcome one or more of the problems due to limitations and disadvantages of the related art.

It is therefore a feature of embodiments of the invention to provide electron emitting devices, which can reduce a driving voltage of a device, e.g., display devices and/or flat lamps, employing such electron emitting devices.

It is therefore another feature of embodiments of the invention to provide electron emitting devices, which can increase a luminous efficiency of a device, e.g., display devices and/or flat lamps, employing such electron emitting devices.

At least one of the above and other features and advantages of the present invention may be realized by providing a device, including a first substrate and a second substrate facing each other, and including a plurality of cells defined between the first and second substrates, an electron accelerating and emitting unit, disposed between the first and second substrates, for accelerating and emitting electrons, a gas including N₂ within the cell, the gas capable of being excited by the electrons emitted by the electron accelerating and emitting unit to generate ultraviolet light, and a light emitting layer disposed on an outer surface of one of the first and second substrates, the light emitting layer capable of being excited by the ultraviolet light to generate visible light.

The electrons emitted from the electron accelerating and emitting unit may have an energy level that is larger than an energy level required to excite the gas in the cell, and smaller than an energy level required to ionize the gas. For example, the electrons may have an energy level at or within a range of about 11 eV to about 16 eV.

The electron accelerating and emitting unit may include a plurality of first electrodes and second electrodes disposed between the first and second substrate, and an electron accelerating layer capable of emitting the electrons to a respective cell when voltages are applied to the first and second electrodes.

The first electrode and the second electrode may be disposed on different surfaces of the respective cell. The first and second electrodes may be disposed on opposing surfaces of the first substrate and the second substrate. One of the first and second electrodes may be disposed on one of the first substrate and the second substrate, and the other of the first and second electrodes may be disposed on a sidewall surface of respective cells. The first and second electrodes may be disposed on both sides of respective cells.

A third electrode may be formed on the first electrode. Voltages applied to the first electrode, the second electrode, and the third electrode are V1, V2, and V3, respectively, the voltages V1, V2, and V3 may satisfy a relationship of V1<V3≦V2. At least one of the second electrode and the third electrode may have a mesh structure.

The first electron accelerating layer may include oxidized porous silicon.

The device may include second electron accelerating layers on the second electrode, and accelerating and emitting electrons that excite the gas into the cell when the voltages are applied to the first and second electrodes. The first electrode and the second electrode may be driven by alternating current (AC) voltages. Third electrodes may be on the first electron accelerating layers, and fourth electrodes formed on the second electron accelerating layers. The third and fourth electrodes have mesh structures. The first and second electron accelerating layers may include oxidized porous silicon.

The first electrodes and the second electrodes may extend in directions crossing each other. The first electrodes and the second electrodes may extend parallel to each other, and the electron emitting device may further include a plurality of address electrodes extending in a direction crossing a direction along which the first and second electrodes extend.

The device may include a dielectric layer covering the address electrodes.

### BRIEF DESCRIPTION OF THE DRAWINGS

The above and other features and advantages of the invention will become more apparent to those of ordinary skill in the art by describing in detail exemplary embodiments thereof with reference to the attached drawings in which:

FIG. 1 illustrates a schematic of a cross-sectional view of a first exemplary embodiment of an electron emitting device;

FIG. 2 illustrates a graph of an energy level of N₂, which may be employed as a gas in embodiments of the invention;

FIG. 3 illustrates a spectrum of UV light generated by excited species in nitrogen;

FIG. 4 illustrates a graph of transmittances of the UV light through a first glass substrate and a second glass substrate according to wavelengths of the UV light;

FIGS. 5A through 5D illustrate waveforms of voltages that may be applied to the electrodes of the electron emitting device of FIG. 1;

FIG. 6 illustrates a schematic of a cross-sectional view of a second exemplary embodiment of an electron emitting device;

FIG. 7 illustrates a schematic of a cross-sectional view of a third exemplary embodiment of an electron emitting device;

FIGS. 8A and 8B illustrate waveforms of voltages that may be applied to electrodes of the electron emitting device of FIG. 7;

FIG. 9 illustrates a schematic of a cross-sectional view of a fourth exemplary embodiment of an electron emitting device;

FIG. 10 illustrates a schematic of cross-sectional view of a fifth exemplary embodiment of an electron emitting device;

FIG. 11 illustrates a schematic of a cross-sectional view of a sixth exemplary embodiment of an electron emitting device; and

FIG. 12 illustrates a schematic of a cross-sectional view of a seventh exemplary embodiment of an electron emitting device.

### DETAILED DESCRIPTION OF THE INVENTION

Korean Patent Application No. 10-2005-0105058, filed on Nov. 3, 2005, in the Korean Intellectual Property Office, and entitled: “Display Device,” is incorporated by reference herein in its entirety.

The invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Various exemplary embodiments of electron emitting devices employing one or more aspects of the invention will be described below. Electron emitting devices may have various structures. For example, an electron emission structure used in a general side conduction electron emitter display (SED) may be employed and/or an electron emission structure using a metal insulator metal (MIM) may be employed. The invention is not limited to these examples.

One or more electron emitting devices may be employed in, e.g., as a display panel, e.g., PDP, or a backlight unit for a display panel, e.g., LCD. For example, as a display panel a plurality of electron emitting devices employing one more aspects of the invention may be arranged in, e.g., a matrix form, and an image(s) may be realized thereon by controlling voltages applied to electrodes thereof. Similarly, a plurality of such electron emitting devices may be arranged adjacent to each other so as to emit light to, e.g., an LCD.

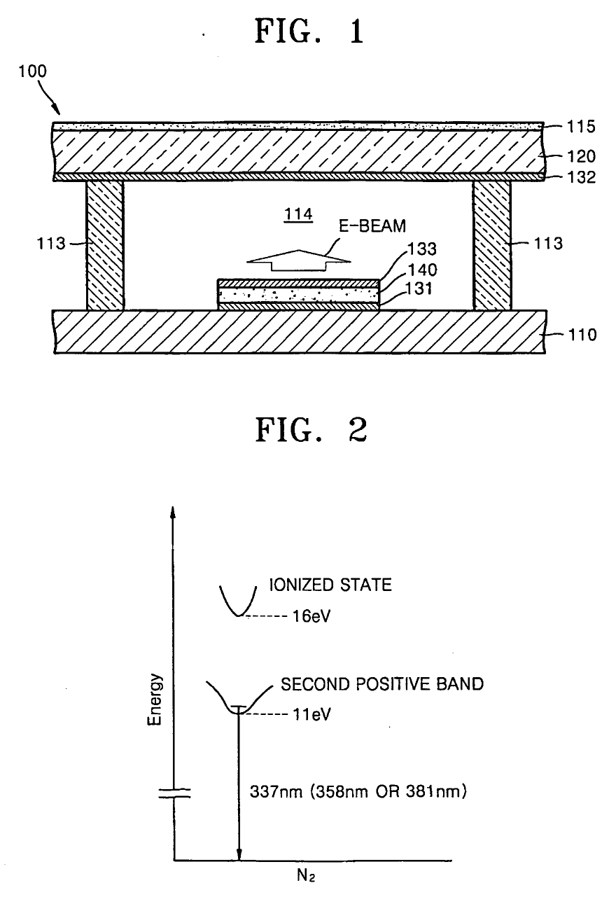

FIG. 1 illustrates a schematic of a cross-sectional view of a first exemplary embodiment of an electron emitting device 100.

Referring to FIG. 1, the electron emitting device 100 may include a first substrate 110, a second substrate 120, a plurality of barrier ribs 113, a cell(s) 114, a first electrode 131, a second electrode 132, a third electrode 133, and an electron accelerating layer 140. The electron emitting device 100 may emit electrons into the cell 114. The electron emitting device 100 will be described in detail below.

The first substrate 110 and the second substrate 120 may face each other with a predetermined interval therebetween. The first substrate 110 and the second substrate 120 may have a high transmittance for visible light, and may be colored to improve bright room contrast. For example, the first substrate 110 and the second substrate 120 may be formed of, e.g., glass. Embodiments of the invention are not limited to such a structure. For example, in other embodiments of the invention, the first substrate 110 and the second substrate 120 may include plastic, and may have flexible structure.

The plurality of barrier ribs 113 may be formed between the first substrate 110 and the second substrate 120. The barrier ribs 113, together with the first and second substrates 110, 120, may define the plurality of cells 114 in a space between the first substrate 110 and the second substrate 120. The barrier ribs 113 may reduce and/or prevent electrical and optical cross talk from occurring between the cells 114.

Display devices employing the electron emitting device 100 may include a plurality of light emitting layers 115. The light emitting layers 115 may be disposed on an outer surface of the second substrate 120. A unit pixel (not shown) of the display device may include one light emitting layer 115 capable of producing a primary color, e.g., a red light emitting layer, a blue light emitting layer, and a green light emitting layer. Each of the cells 114 may be associated with one of the light emitting layers 115. For example, each of the cells 114 may be associated one of the red, green or blue light emitting layers 115. For example, the red light emitting layer may be formed on a portion of the outer surface of the second substrate 120, which corresponds to a red cell, the green light emitting layer may be formed on a portion of the outer surface of the second substrate 120, which corresponds to a green cell, and the blue light emitting layer may be formed on a portion of the outer surface of the second substrate 120, which corresponds to a blue cell.

In the description of exemplary embodiments herein, the light emitting layer 115 may correspond to a material layer that generates visible light in response to UV light. In embodiments of the invention, the light emitting layer 115 may include quantum dots.

A gas including N₂ may fill the cells 114. If the gas is N₂, the gas may generate UV light having long wavelengths. However, the invention is not limited to a gas including N₂. For example, the gas may include various kinds of gases such as Xe. In the following description, the gas refers to a gas that is excited by external energy, .e.g., accelerated electrons, to generate the UV light. Also, the gas employed in one or more aspects of the invention may be employed as the discharge gas.

The first electrode 131 may be formed in each of the cells 114 on the first substrate 110. The second electrode 132 may be formed in each cell 114 on a lower surface of the second substrate 120, and may extend along a direction of crossing a direction along which the first electrode 131 extends. The first and second electrodes 131 and 132 may be a cathode and an anode, respectively. The second electrode 132 may include a transparent conductive material, e.g., an indium tin oxide (ITO). In addition, a dielectric layer (not shown) may be formed on the second electrode 132.

The electron accelerating layer 140 may be formed on the first electrode 131. The third electrode 133, e.g., a grid electrode, may be formed on the electron accelerating layer 140. The electron accelerating layer 140 may be formed of any material that can accelerate the electrons, and may include, e.g., oxidized porous silicon. More particularly, the oxidized porous silicon may be, e.g., oxidized porous poly silicon and/or oxidized porous amorphous silicon.

The electron accelerating layer 140 may include, e.g., carbon nanotube and/or boron nitride bamboo shoot (BNBS). The BNBS may include an sp³ bonding 5H-BN, which is a material developed by National Institute for Material Science (NIMS) of Japan and was made public in March, 2004. BNBS is very hard and has a very stable structure. BNBS is harder than any other material, except for diamond. In addition, BNBS is transparent at or in a wavelength range of about 380 nm to about 780 nm, which is the visible light region, and BNBS has negative electron affinity. Therefore, the electron emitting property of the BNBS is very high (Handbook of refractory carbides and nitrides, Hugh O. Pierson, Noyes Publication, Table 13.6 P236, 1996).

A brief description of an operation of the electron emitting units 100 will be described below. When predetermined voltages are respectively applied to the first electrode 131 and the third electrode 133 (and/or the second electrode 132), the electron accelerating layer 140 may accelerate the electrons induced from the first electrode 131 and may emit the electrons into the cell 114 through the third electrode 133. In the first exemplary embodiment, the electrons may be emitted as E-beams. The E-beams emitted into the cell 114 may excite the gas, and the excited gas may generate the UV light, while the gas may be stabilizing. The UV light may transmit through the second substrate 120, before exciting the light emitting layer 115 to generate the visible light for realizing an image(s) on the display device employing the electron acceleration and emission unit 100.

The E-beam may have an energy level that is larger than an energy level required to excite N₂ and smaller than an energy level required to ionize the gas. Therefore, voltages, having an electron energy, which may be optimized for exciting the gas using the E-beams, may be applied to the first electrode 131, the third electrode 133, and/or the second electrode 132.

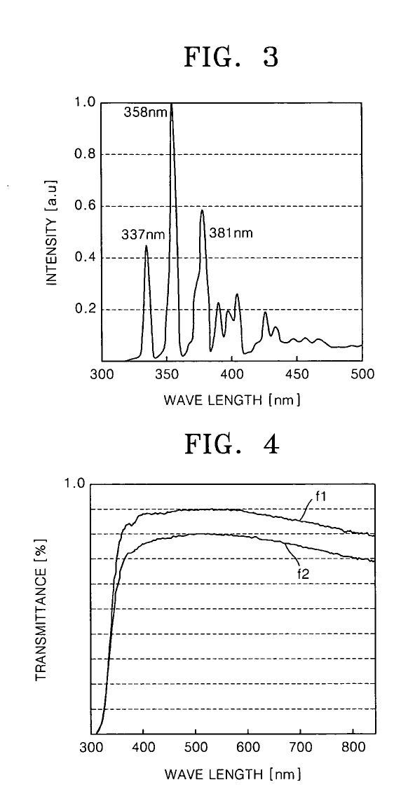

FIG. 2 illustrates a graph of an energy level of N₂, which may be a source for generating UV light. Referring to FIG. 2, 16 eV is required to ionize N₂, and 11 eV or more of energy is required to excite N₂. FIG. 3 illustrates a second positive band spectrum of the UV light that may be generated by excited species in N₂. Referring to FIG. 3, the excited N₂ has peaks at 337 nm, 358 nm, and 381 nm, while stabilizing. Accordingly, the energy of the E-beam that may be emitted into the cell 114 by the electron accelerating layer 140 may be at or in a range of about 11 eV to about 16 eV in order to excite N₂.

FIG. 4 illustrates a graph of transmittances of UV light according to the wavelengths of the UV light when the UV light is transmitted through first and second glass substrates. The first glass substrate may be transparent glass substrate, and may have a thickness of 2.8 mm. The second glass substrate may be formed on an inner surface of the first glass substrate in a predetermined pattern and may be formed of ITO. In addition, first curve f1 in FIG. 4 denotes the transmittance of the UV light transmitting the first glass substrate, and second curve f2 of FIG. 4 denotes the transmittance of the UV light transmitting the second glass substrate.

For example, in a case where the UV light has wavelengths of 337 nm, 358 nm, and 381 nm, the transmittances of the UV light through the second glass substrate are about 31%, 66%, and 73%, respectively. That is, the UV light generated by N₂ gas in the cells 114 can sufficiently excite the light emitting layers 115 formed on the second substrate 120.

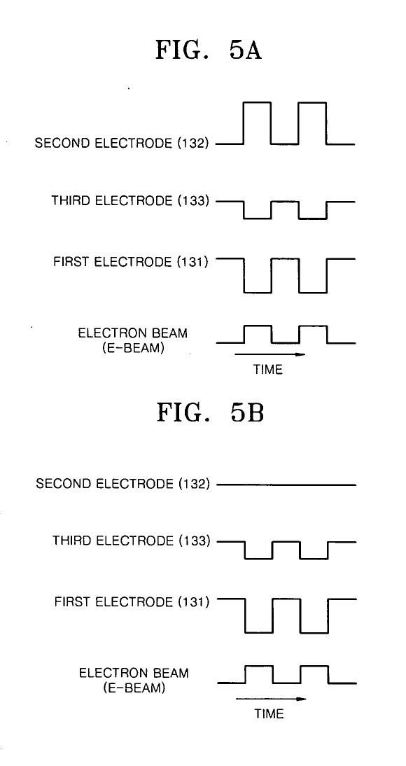

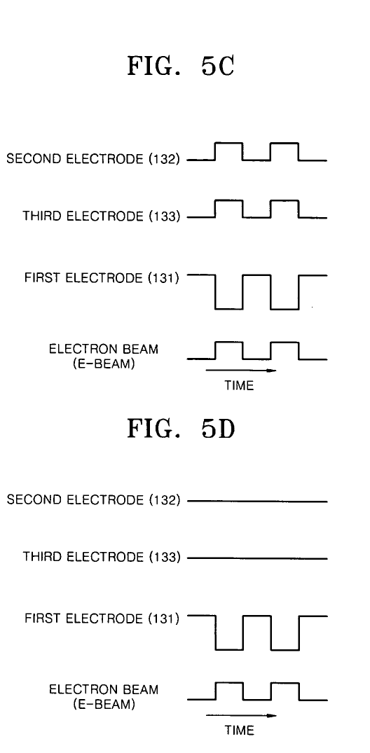

FIGS. 5A through 5D illustrate waveforms of voltages that may be applied to the electrodes of the electron emitting device of FIG. 1.

Referring to FIG. 5A, pulse type voltages may be respectively applied to the first, second, and third electrodes 131, 132, and 133. Assuming that the voltages applied to the first, second, and third electrodes 131, 132, and 133 are V1, V2, and V3, respectively, the voltages may satisfy a relationship of V1<V3<V2. When the voltages are applied to the electrodes 131, 132, and 133, the E-beams (E-beam) may be emitted into the cells 114 by the electron accelerating layer 140. The E-beams (E-beam) may be accelerated toward the second electrode 132 by the voltages applied to the third and second electrodes 133 and 132, and the gas may be excited. The gas may be discharged by controlling the voltage applied to the second electrode 132. In embodiments of the invention, the second electrode 132 may be grounded, as shown in FIG. 5B. In such embodiments, the electrons reaching the second electrode 132 may escape outside of the cell 114.

Referring to FIG. 5C, assuming that the voltages applied to the first, second, and third electrodes 131, 132, and 133 are V1, V2, and V3, in embodiments of the invention, the voltages may be set to satisfy a relationship of V1<V3=V2. When the voltages V1, V2, V3 are applied to the electrodes 131, 132, 133, the E-beam (E-beam) may be emitted into the cells 114 through the electron accelerating layer 140 by the voltages V1, V3 applied to the first and third electrodes 131 and 133, and the gas may be excited by the E-beam (E-beam). The second and third electrodes 132 and 133 may be grounded, as shown in FIG. 5D. In this case, the electrons reaching the second electrode 132 may escape to the outside of the cell 114.

In the following description of other exemplary embodiments, in general, only differences from the first exemplary embodiment of the electron emitting device described above will be described.

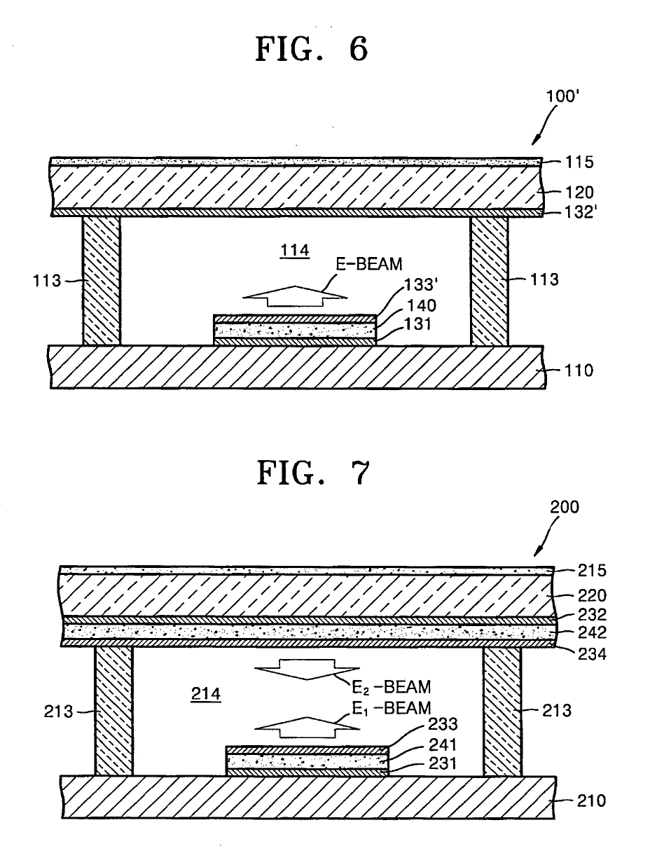

FIG. 6 illustrates a schematic of a cross-sectional view of a second exemplary embodiment of an electron emitting device 100′. The electron emitting device 100′ substantially corresponds to the electron emitting device 100 illustrated in FIG. 1, but for employing a second electrode 132′ and a third electrode 133′ in lieu of the first electrode 132 and third electrode 133. Referring to FIG. 6, the second electrode 132′ may be formed as a mesh so that visible light generated in the cell 114 may be transmitted therethrough. In such embodiments, the third electrode 133′ may also be formed as a mesh so that the electrons accelerated by the electron accelerating layer 140 may be easily emitted into the cell(s) 114.

FIG. 7 illustrates a schematic of a cross-sectional view of a third exemplary embodiment of an electron emitting device 200.

Referring to FIG. 7, the electron emitting device 200 may include a first substrate 210, a second substrate 220, a first electrode 231, a second electrode 232, a third electrode 233, a fourth electrode 234, a plurality of barrier ribs 213, a cell 214, a first electron adjusting layer 241, and a second electron adjusting layer 242.

The first substrate 210 and the second substrate 220 may extend parallel to each other with a predetermined distance therebetween. The plurality of barrier ribs 213 may be arranged in a space between the first and second substrates 210 and 220, and together with the first and second substrates 210, 220 may define the cell(s) 214 between the first and second substrates 210 and 220. A gas including N₂ may be filled in the cells 214. If the gas is N₂, the gas may generate UV light having a long wavelength.

The first electrode 231 may be formed in each cell(s) 214 on the first substrate 210. The second electrode 232 may be formed in each of the cells 214 on a lower surface of the second substrate 220, and the second electrode 232 may extend along a direction of crossing a direction along which the first electrode 231 extends. The first electron accelerating layer 241 and the second electron accelerating layer 242 may be formed on the first and second electrodes 231 and 232, respectively. The third electrode 233 and the fourth electrode 234 may be formed on the first and second electron accelerating layers 241 and 242, respectively.

The third electrode 233 and the fourth electrode 234 may be grid electrodes. The first and second electron accelerating layers 241 and 242 may include any material that may accelerate the electrons, and may include oxidized porous silicon. The oxidized porous silicon may be, e.g., oxidized porous poly silicon and/or oxidized porous amorphous silicon. The first and second electron accelerating layers 241 and 242 may include carbon nanotube and/or BNBS.

When predetermined voltages are applied to the first electrode 231, the third electrode 233, and/or the second electrode 232, the first electron accelerating layer 241 may accelerate the electrons induced from the first electrode 231 to emit a first electron beam (E₁-beam) into the cell 214 through the third electrode 233. When predetermined voltages are applied to the second electrode 232, the fourth electrode 234, and/or the first electrode 231, the second electron accelerating layer 242 may accelerate the electrons induced from the second electrode 232 to emit a second electron beam (E₂-beam) into the cell 214 through the fourth electrode 234.

The first and second electron beams (E₁-beam, E₂-beam) may be alternately emitted into the cell 214 because an alternating current (AC) voltage may be applied between the first and second electrodes 231 and 232. Each of the first and second electron beams (E₁-beam, E₂-beam) may excite the gas, and the excited gas may generate the UV light that may excite the light emitting layer 215, while the gas itself is stabilizing. Therefore, energy levels of the first and second electron beams (E₁-beam, E₂-beam) may be larger than the energy level required to excite the gas, and smaller than the energy level required to ionize the gas, as described above. As discussed above, the energy levels of the first and second electron beams (E₁-beam, E₂-beam) may be at or in a range of about 11 eV to about 16 eV.

The second and fourth electrodes 232 and 234 may include a transparent conductive material, e.g., ITO, so that the visible light may be transmit through the second and fourth electrodes 232 and 234. The third and fourth electrodes 233 and 234 may be formed as meshes so that the electrons accelerated by the first and second electron accelerating layers 241 and 242 may be relatively easily emitted into the cell(s) 214. One of the first substrate 210 and the second substrate 220 may further include one or more electrodes (not shown).

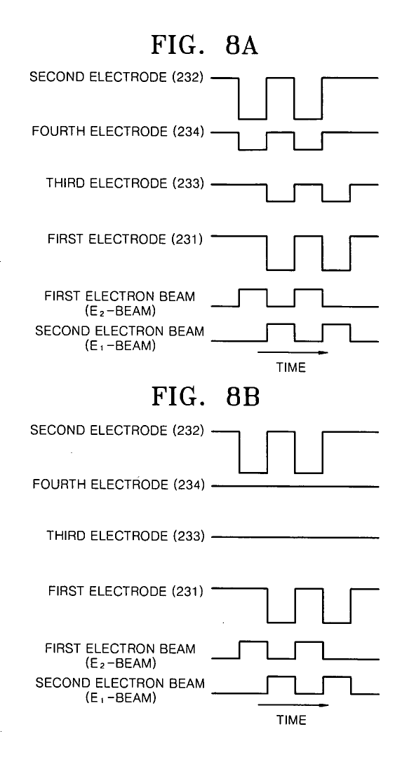

In embodiments of the invention employing the electron emitting device 200, voltages illustrated in FIGS. 8A and 8B and described below, may be applied to the electrodes of the electron emitting device 200.

Display devices employing the electron emitting device 200 may include a plurality of light emitting layers 215 and multiple ones of the cells 214. The light emitting layer 215, e.g., red, green, or blue light emitting layer, corresponding to each of the cells 214, e.g., red, green or blue cell, may be arranged on a corresponding portion of an outer surface of the second substrate 220.

FIGS. 8A and 8B illustrate waveforms of voltages that may be applied to electrodes of the electron emitting device 200 illustrated in FIG. 7.

Referring to FIG. 8A, pulse type voltages may be applied to the first, second, third, and fourth electrodes 231, 232, 233, and 234, respectively. Assuming that the voltages applied to the first, second, third, and fourth electrodes 231, 232, 233, and 234 are V1, V2, V3, and V4, the voltages may satisfy relationships of V1<V3 and V2<V4. When the voltages V1, V2, V3, V4 are applied to the electrodes 231, 232, 233, 234, the first electron beam (E₁-beam) may be emitted into the cell 214 through the first electron accelerating layer 241 as a result of the voltages V1. V3 and/or V2 that may be respectively applied to the first electrode 231, the third electrode 233, and/or the second electrode 232. The second electron beam (E₂-beam) may be emitted into the cell 214 through the second electron accelerating layer 242 by the voltages V2, V4 and/or V1 that may be respectively applied to the second electrode 232, the fourth electrode 234, and/or the first electrode 231. Because an AC voltage may be applied between the first electrode 231 and the second electrode 232, the first and second electron beams (E₁-beam, E₂-beam) may be alternately into the cell 213 and excite the gas. As illustrated in FIG. 8B, the third and fourth electrodes 233 and 234 may be grounded.

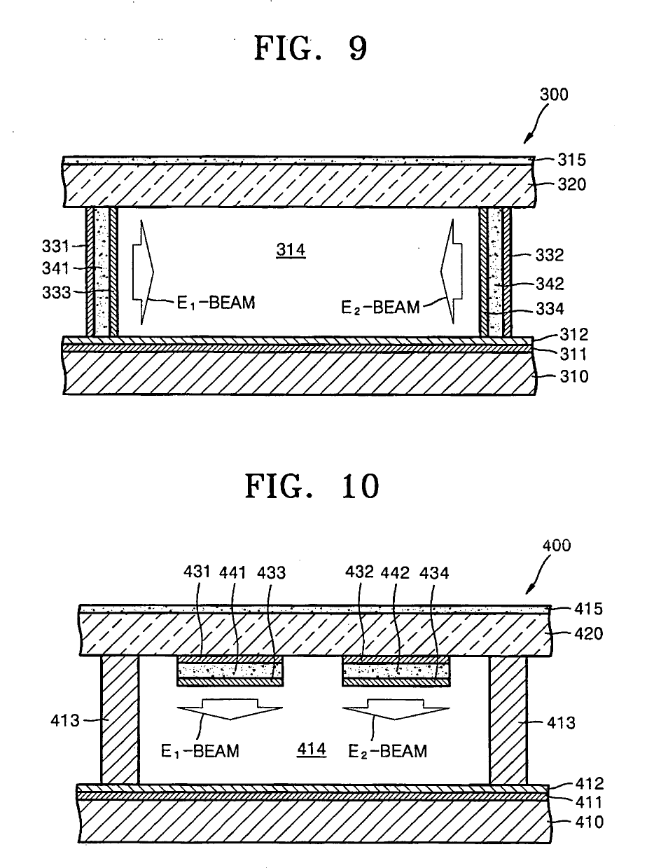

FIG. 9 illustrates a schematic of a cross-sectional view of a fourth exemplary embodiment of an electron emitting device 300.

Referring to FIG. 9, the electron emitting device 300 may include a first substrate 310, a second substrate 320, pairs of first electrodes 331 and second electrodes 332, third electrodes 333, fourth electrodes 334, a cell(s) 314, first and second electron accelerating layers 341, 342, and a dielectric layer 312. The electron emitting device 300 may also include an address electrode 311. The first substrate 310 and the second substrate 320 may face each other with a predetermined space therebetween.

One or more of the cell(s) 314 may be defined in the space between the first and second substrates 310, 320. The respective address electrodes 311 may be formed on the first substrate 310, and the address electrodes 311 may be embedded in the dielectric layer 312. A gas including N₂ may be filled in the cells 314. If the gas is N₂, the gas may generate UV light having a long wavelength.

The pair of first and second electrodes 331 and 332 may be formed in each cell 314 between the first and second substrates 310 and 320. The first and second electrodes 331 and 332 may be respectively disposed on opposing sides of the cell 314 extending between the first and second substrates 310, 320. The first electron accelerating layer 341 and the second electron accelerating layer 342 may be formed on inner surfaces of the first and second electrodes 331 and 332. The third electrode 333 and the fourth electrode 334 may be formed on the first and second electron accelerating layers 341 and 342.

The first and second electron accelerating layers 341 and 342 may include any material that may accelerate the electrons, and may include oxidized porous silicon. The oxidized porous silicon may be, e.g., oxidized porous poly silicon or oxidized porous amorphous silicon. The first and second electron accelerating layers 341 and 342 may include carbon nanotube and/or BNBS.

The third and fourth electrodes 333 and 334 may be formed as meshes so that the electrons accelerated by the first and second electron accelerating layers 341 and 342 may be relatively easily emitted into the cells 314. The first and second electron accelerating layers 341 and 342 may define the space between the first and second substrates 310 and 320, and thus, together with the first and second substrates 310, 320 may define the cell(s) 314. A plurality of barrier ribs (not shown) may be formed between the first and second substrates 310 and 320 to define the space between the first and second substrates 310 and 320 and form the cells 314.

The first electron accelerating layer 341 may emit a first electron beam (E₁-beam) into the cell 314 when predetermined voltages are respectively applied to the first electrode 331, the third electrode 333, and/or the second electrode 332. The second electron accelerating layer 342 may emit a second electron beam (E₂-beam) into the cell 314 when the predetermined voltages are respectively applied to the second electrode 332, the fourth electrode 334, and/or the first electrode 331. The first and second electron beams (E₁-beam, E₂-beam) may be alternately emitted into the cell 314 because an AC voltage may be applied between the first electrode 331 and the second electrode 332.

Each of the first and second electron beams (E₁-beam, E₂-beam) may excite the gas, and the excited gas may generate the UV light that may excite the light emitting layer 314, while the gas itself is stabilized. As discussed above, energy levels of the first and second electron beams (E₁-beam, E₂-beam) may be larger than the energy level required to excite the gas, and may be smaller than the energy level required to ionize the gas. More particularly, as described above, the energy levels of the first and second electron beams (E₁-beam, E₂-beam) may be at or in a range of about 11 eV to about 16 eV.

Display devices employing the electron emitting device 300 may include multiple ones of the cells 314, and a plurality of light emitting layers 315. The light emitting layers 315 may be disposed on a corresponding outer surface of the second substrate 320. A unit pixel (not shown) of the display device may include one light emitting layer 315 capable of producing a primary color, e.g. a red light emitting layer, a blue light emitting layer, and a green light emitting layer. Each of the cells 314 may be associated with one of the light emitting layers 315.

In embodiments of the invention employing the electron emitting device 300, the voltages illustrated in FIGS. 8A and 8B and described above, may be applied to the electrodes of the electron emitting device 300.

FIG. 10 illustrates a schematic of cross-sectional view of a fifth exemplary embodiment of an electron emitting device 400.

Referring to FIG. 10, the electron emitting device 400 may include a first substrate 410, a second substrate 420, a first electrode 431, a second electrode 432, a third electrode 433, a plurality of barrier ribs 413, a cell 414, a first electron accelerating layer 441, and a second electron accelerating layer 442. The electron emitting device 400 may also include an address electrode 411. The first substrate 410 and the second substrate 420 may be arranged parallel to each with a predetermined space therebetween. The plurality of barrier ribs 413 may be arranged between the first substrate 410 and the second substrate 420. Together with the first substrate 410 and the second substrate 420, the plurality of barrier ribs 413 may define the cell(s) 414 between the first and second substrates 410 and 420.

A gas including N₂ may be filled in the cells 414. If the gas is N₂, the gas may generate UV light having a long wavelength.

The address electrode 411 may be formed on the first substrate 410, and the address electrode 411 may be covered by a dielectric layer 412. The pair of the first electrode 431 and the second electrode 432 may be formed at each cell 414 on a lower surface of the second substrate 420. The first and second electrodes 431 and 432 may be formed in a direction crossing a direction along which the address electrode 411 extends.

In addition, the first electron accelerating layer 441 and the second electron accelerating layer 442 may be formed on lower surfaces of the first and second electrodes 431 and 432. The third electrode 433 and the fourth electrode 434 may be formed on lower surfaces of the first and second electron accelerating layer 441 and 442. The first and second electron accelerating layer 441 and 442 may include any material that can accelerate the electrons, and may include oxidized porous silicon. The oxidized porous silicon may be, e.g., oxidized porous poly silicon or oxidized porous amorphous silicon. In addition, the first and second electron accelerating layers 441 and 442, and/or may include carbon nanotube or BNBS.

When predetermined voltages are applied to the first electrode 431, the third electrode 433, and/or the second electrode 432, the first electron accelerating layer 441 may emit a first electron beam (E₁-beam) into the cell 414. When predetermined voltages are applied to the second electrode 431, the fourth electrode 434, and/or the first electrode 431, the second electron accelerating layer 442 may emit a second electron beam (E₂-beam) into the cell 414. The first and second electron beams (E₁-beam, E₂-beam) may be alternately emitted into the cell 414 because the AC voltage may be applied between the first and second electrodes 431 and 432.

Each of the first and second electron beams (E₁-beam, E₂-beam) may excite the gas, and the excited gas may generate the UV light that excites the light emitting layer 415, while the gas itself is stabilizing. Therefore, as discussed above, the energy levels of the first and second electron beams (E₁-beam, E₂-beam) may be larger than the energy level required to excite the gas, and smaller than the energy level required to ionise the gas. More particularly, as described above, the energy levels of the first and second electron beams (E₁-beam, E₂-beam) may be at or in a range of about 11 eV to about 16 eV.

The first, second, third, and fourth electrodes 431, 432, 433, and 434 may include a transparent conductive material, e.g., ITO, so that the visible light may be transmitted through the first, second, third and/or fourth electrodes 431, 432, 433, 434. The third and fourth electrodes 433 and 434 may be formed as meshes so that the electrons accelerated by the first and second electron accelerating layers 441 and 442 may be relatively easily emitted into the cells 414.

In embodiments of the invention employing the electron emitting device 400, the voltages illustrated in FIGS. 8A and 8B and described above, may be applied to the electrodes of the electron emitting device 400.

Display devices employing the electron emitting device 400 may include multiple ones of the cells 414, and a plurality of light emitting layers 415. The light emitting layers 415 may be disposed on a corresponding outer surface of the second substrate 420. A unit pixel (not shown) of the display device may include one light emitting layer 415 capable of producing a primary color, e.g. a red light emitting layer, a blue light emitting layer, and a green light emitting layer. Each of the cells 414 may be associated with one of the light emitting layers 415.

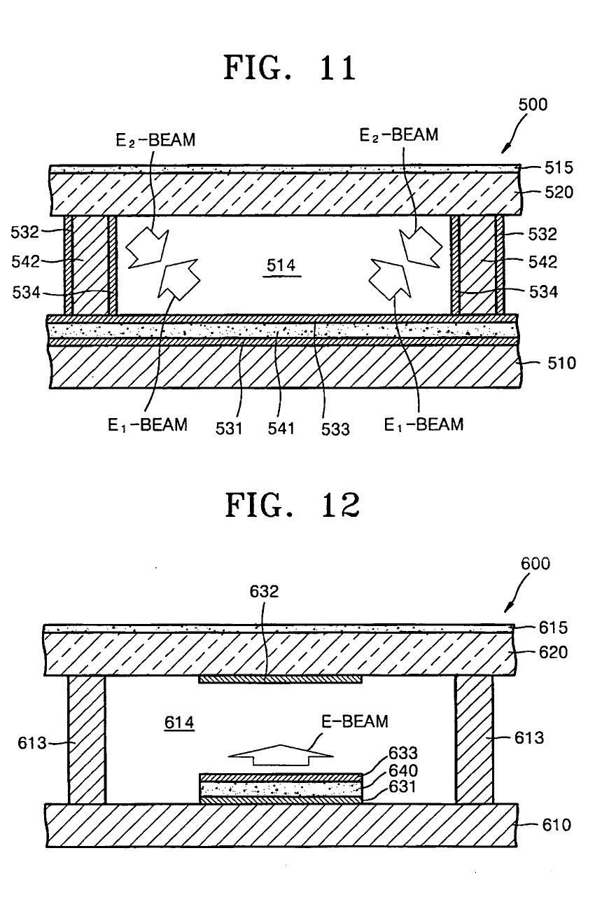

FIG. 11 illustrates a schematic of a cross-sectional view of a sixth exemplary embodiment of an electron emitting device 500.

Referring to FIG. 11, the electron emitting device 500 may include a first substrate 510, a second substrate 520, a cell 514, a first electrode 531, a pair of second electrodes 532, a first electron accelerating layer 541, and a second electron accelerating layer 542. The first substrate 510 and the second substrate 520 may be arranged parallel to each with a predetermined space therebetween. The cell(s) 514 may be defined in the space between the first and second substrates 510, 520. A gas including N₂ may fill the cell(s) 514. If the gas is N₂, the gas may generate UV light having a long wavelength.

The first electrode 531 and the pair of second electrodes 532 may be formed in each of the cells 514 between the first and second substrates 510, 520. The first electrode 531 may be disposed on an upper surface of the first substrate 510, and the second electrodes may be disposed on both sides of the cell 514. The first electrode 531 may extend along a direction that crosses a direction along which the second electrodes 532 extend.

A first electron accelerating layer 541 and a second electron accelerating layer 542 may be formed on inner surfaces of the first and second electrodes 531 and 532. A third electrode 533 and a fourth electrode 534 may be formed on the first and second electron accelerating layers 541 and 542. The first and second electron accelerating layers 541 and 542 may include any material that may accelerate the electrons, and may include oxidized porous silicon. The oxidized porous silicon may be, e.g., oxidized porous poly silicon and/or oxidized porous amorphous silicon. The first and second electron accelerating layers 541 and 542 may include carbon nanotube and/or BNBS.

When predetermined voltages are applied to the first electrode 531, the third electrode 533 and/or the second electrode 532, the first electron accelerating layer 541 may emit a first electron beam (E₁-beam) into the cell 514. When predetermined voltages are applied to the second electrode 532, the fourth electrode 534, and/or the first electrode 531, the second electron accelerating layer 542 may emit a second electron beam (E₂-beam) into the cell 514. The first and second electron beams (E₁-beam, E₂-beam) may be alternately emitted into the cell 514 because the AC voltage may be applied between the first and second electrodes 531 and 532. Each of the first and second electron beams (E₁-beam, E₂-beam) may excite the gas, and the excited gas may generate the UV light that excites the light emitting layer 515, while the gas itself is stabilizing. As discussed above, the energy levels of the first and second electron beams (E₁-beam, E₂-beam) may be larger than the energy level required to excite the gas, and smaller than the energy level required to ionise the gas. More particularly, as discussed above, the energy levels of the first and second electron beams (E₁-beam, E₂-beam) may be at or in a range of about 11 eV to about 16 eV.

The third and fourth electrodes 533 and 534 may be formed as meshes so that the electrons accelerated by the first and second electron accelerating layers 541 and 542 may be easily emitted into the cell 514. The second electron accelerating layers 542 may define the space between the first and second substrates 510 and 520, and thus, together with the first and second substrates 510, 520 may define the cells 514. A plurality of barrier ribs (not shown) may be formed between the first and second substrates 510 and 520 to define the space between the first and second substrates 510, 520 and to form the cells 514 may be further disposed between the first and second substrates 510 and 520.

In embodiments of the invention employing the electron emitting device 500, the voltages illustrated in FIGS. 8A and 8B and described above, may be applied to the electrodes of the electron emitting device 500.

Display devices employing the electron emitting device 500 may include multiple ones of the cells 514, and a plurality of light emitting layers 515. The light emitting layers 515 may be disposed on a corresponding outer surface of the second substrate 520. A unit pixel (not shown) of the display device may include one light emitting layer 515 capable of producing a primary color, e.g. a red light emitting layer, a blue light emitting layer, and a green light emitting layer. Each of the cells 514 may be associated with one of the light emitting layers 515.

The display device according to the invention can be applied to a flat panel lamp that is mainly used as a back light unit of a liquid crystal display (LCD).

FIG. 12 illustrates a schematic of a cross-sectional view of a seventh exemplary embodiment of an electron emitting device.

Referring to FIG. 12, a first substrate 610, a second substrate 620, a cell 614, spacers 613, a first electrode 631, a second electrode 632, a third electrode 633, and an electron accelerating layer 640. The first substrate 610 and the second substrate 620 may be arranged parallel to each other with a predetermined distance therebetween. The first and second substrates 610 and 620 may be, e.g., glass substrates. The spacers 613 may be formed between the first and second substrates 610 and 620, and together with the first and second substrates 610, 620 may define the cell(s) 614.

A gas including N₂ may be filled in the cells 614. If the gas is N₂, the gas may generate UV light having long wavelengths.

The first electrode 631 corresponding to the cell(s) 614 may be formed on an upper surface of the first substrate 610, and the second electrode 632 corresponding to cell(s) 614 may be formed on a lower surface of the second substrate 620 parallel to the first electrode 631. The first and second electrodes 631 and 632 may be a cathode and an anode, respectively. The second electrode 632 may be formed of a transparent conductive material, e.g., ITO, so that the visible light may transmit the second electrode 632. In embodiments of the invention, the second electrode 632 may be formed as a mesh. The electron accelerating layer 640 may be formed on the upper surface of the first electrode 631, and the third electrode 633 may be formed on the electron accelerating layer 640. The electron accelerating layer 640 may include any material that may accelerate the electrons, and may include, e.g., oxidized porous silicon. The oxidized porous silicon may be, e.g., oxidized porous poly silicon and/or oxidized porous amorphous silicon. The electron accelerating layers 640 may include, e.g., carbon nanotube or BNBS.

When predetermined voltages are applied to the first electrode 631, the third electrode 633, and/or the second electrode 632, the electron accelerating layer 640 may accelerate the electrons induced from the first electrode 631 to emit electron beam (E-beam) into the cell 614 through the third electrode 633. The electron beam (E-beam) emitted into the cell 614 may excite the gas in the cell 614, and the excited gas may generate UV light while the gas is stabilizing. The UV light may excite the light emitting layer 615 to generate visible light. The third electrode 633 may be formed as a mesh so that the electrons accelerated by the electron accelerating layer 649 may be emitted into the cell 614.

As described above, the energy level of the electron beam (E-beam) may be larger than the energy level required to excite the gas, and smaller than the energy level required to ionize the gas. More particularly, as described above, the energy level of the electron beam (E-beam) may be at and/or in a range of about 11 eV to about 16 eV.

In embodiments of the invention employing the electron emitting device 600, the voltages illustrated in FIGS. 8A and 8B and described above, may be applied to the electrodes of the electron emitting device 600.

Display devices employing the electron emitting device 600 may include multiple ones of the cells 614, and a plurality of light emitting layers 615. The light emitting layers 615 may be disposed on a corresponding outer surface of the second substrate 620. A unit pixel (not shown) of the display device may include one light emitting layer 615 capable of producing a primary color, e.g. a red light emitting layer, a blue light emitting layer, and a green light emitting layer. Each of the cells 614 may be associated with one of the light emitting layers 615.

Embodiments of the invention provide electron emitting devices that may be capable of emitting light for displaying images on a display device without needing to ionize a gas housed in cell(s) of the display device. That is, embodiments of the invention may provide electron emitting devices that may be capable of emitting light for displaying images on the display device while only exciting the light emitting material/gas housed in the cell(s). Therefore, embodiments of the invention may enable the driving voltage of a device, e.g., display device or flat lamp, employing such an electron emitting device to be lowered, while improving brightness and luminous efficiency of the device.

Embodiments of the invention may employ N₂ gas, as the gas that may fill the cell(s). Thus, embodiments of the invention enable costs for manufacturing, e.g., a display device, and/or a flat lamp, to be reduced and a manufacturing method thereof to be simplified.

Embodiments of the invention may enable UV light having long wavelength(s) to be generated, and thus, a transport efficiency of the UV light and the efficiency of the respective light emitting material may be improved, and the display process may be performed with high efficiency. For example, if UV light having a wavelength of 330 nm or longer is used to excite the gas, a stokes efficiency of the light emitting material may be about two times higher than that of using the UV light having a wavelength of 147 nm. Also, transmittance of the UV light through the first and second substrates may be improved.

Exemplary embodiments of the invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the invention as set forth in the following claims.

What is claimed is:

1. A device, comprising:
a first substrate and a second substrate facing each other, and including a plurality of cells defined between the first and second substrates;
an electron accelerating and emitting unit, disposed between the first and second substrates, for accelerating and emitting electrons;
a gas including N₂ within the cell, the gas capable of being excited by the electrons emitted by the electron accelerating and emitting unit to generate ultraviolet light; and
a light emitting layer disposed on an outer surface of one of the first and second substrates, the light emitting layer capable of being excited by the ultraviolet light to generate visible light.

2. The device as claimed in claim 1, wherein the electrons emitted from the electron accelerating and emitting unit have an energy level that is larger than an energy level required to excite the gas in the cells, and smaller than an energy level required to ionize the gas.

3. The device as claimed in claim 2, wherein the electron has an energy level at or within a range of about 11 eV to about 16 eV.

4. The device as claimed in claim 1, wherein the electron accelerating and emitting unit comprises:
a plurality of first electrodes and second electrodes disposed between the first and second substrate; and
an electron accelerating layer capable of emitting the electrons to a respective cell when voltages are applied to the first and second electrodes.

5. The device as claimed in claim 4, wherein the first electrode and the second electrode are disposed on different surfaces of the respective cell.

6. The device as claimed in claim 5, wherein the first and second electrodes are disposed on opposing surfaces of the first substrate and the second substrate.

7. The device as claimed in claim 5, wherein one of the first and second electrodes is disposed on one of the first substrate and the second substrate, and the other of the first and second electrodes is disposed on a sidewall surface of respective cells.

8. The device as claimed in claim 5, wherein the first and second electrodes are disposed on both sides of respective cells.

9. The device as claimed in claim 4, further comprising a third electrode formed on the first electrode.

10. The device as claimed in claim 9, wherein when voltages applied to the first electrode, the second electrode, and the third electrode are V1, V2, and V3, respectively, the voltages V1, V2, and V3 satisfy a relationship of V1<V3≦V2.

11. The device as claimed in claim 9, wherein at least one of the second electrode and the third electrode has a mesh structure.

12. The device as claimed in claim 4, wherein the first electron accelerating layer includes oxidized porous silicon.

13. The device as claimed in claim 4, further comprising second electron accelerating layers formed on the second electrode, and accelerating and emitting electrons that excite the gas into the cell when the voltages are applied to the first and second electrodes.

14. The device as claimed in claim 13, wherein the first electrode and the second electrode are driven by alternating current (AC) voltages.

15. The device as claimed in claim 14, further comprising:
third electrodes formed on the first electron accelerating layers, and fourth electrodes formed on the second electron accelerating layers.

16. The device as claimed in claim 15, wherein the third and fourth electrodes have mesh structures.

17. The device as claimed in claim 13, wherein the first and second electron accelerating layers include oxidized porous silicon.

18. The device as claimed in claim 4, wherein the first electrodes and the second electrodes extend in directions crossing each other.

19. The device as claimed in claim 4, wherein the first electrodes and the second electrodes extend parallel to each other, and the electron emitting device further includes a plurality of address electrodes extending in a direction crossing a direction along which the first and second electrodes extend.

20. The device as claimed in claim 19, further comprising a dielectric layer covering the address electrodes.
